(19) United States
(12) Patent Application Publication
(10) Pub. No.: US 2001/0020224 A1
(43) Pub. Date: Sep. 6, 2001

(54) Logic emulation processor and module unit thereof

(76) Inventor: Hiroshi Tomita, Hadano (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/764,284

(22) Filed: Jan. 19, 2001

(30) Foreign Application Priority Data
Mar. 2, 2000 (JP) 2000-061838

(51) Int. Cl. G06F 9/455

(52) U.S. Cl. 703/23

(57) ABSTRACT

A software-based logic emulation system is made up of a combination circuit processor which emulates a combination circuit model or memory model, a number of multiple control processors which mainly emulate sequential circuit models and provide input signals to the combination circuit processor, and a number of multiplexers which select outputs of the combination circuit processor and deliver the selected outputs to the control processors.

### BACKGROUND OF THE INVENTION

The present invention relates to a logic emulation processor for logic circuits and the arrangement of module units which constitute the processor.

Logic emulation is a known technique, and it falls into a scheme using FPGAs (Field Programmable Gate Arrays) and a scheme using logic emulation processors.

The scheme based on FPGAs operates to load programming words into a system in which a number of FPGAs and a number of switching devices are connected together and carry out the emulation. Programming words represent a digital circuit model which has been converted into structural information of FPGAs and structural information of switching devices. Specifically, a digital circuit model is divided into a number of partial circuits, with each circuit being rendered the logical composition, automatic layout and automatic wiring and converted into programming words.

Although the scheme using FPGAs has a bottleneck of data transfer between FPGAs due to a limited number of pins of FPGA, it is fast in emulation performance which is derived directly from the operation speed of FPGA. However, it necessitates a time-consuming task of circuit division and logical composition and the automatic layout and automatic wiring at each alteration of logical design.

The scheme based on logic emulation processors (e.g., the invention entitled “Emulation System” of Japanese Laid-Open Publication No. Hei-09-101975 and the invention entitled “Check Pointing in an Emulation System” of U.S. Pat. No. 5,822,564) is designed to load an emulation program into a system in which a number of logic emulation processors are connected together and operate the system to execute the emulation program. An emulation program which performs a digital circuit model is a compiled object program which can be run by a logic emulation processor.

Compilation is implemented in the following procedure. Initially, a technical mapping process converts the digital circuit model into a number of subordinate circuits of unit size which can be emulated in one step, and the subordinate circuits are mapped onto the logic emulation processors in one-to-one correspondence. Subsequently, a scheduling process determines the order of emulation of the subordinate circuits so that their emulations take place sequentially. Finally, a routing process routes the data transaction among the logic emulation processors. The resulting technical mapping data, scheduling data and routing data become an emulation program.

The scheme based on logic emulation processors is featured by a short compilation time. However, the scheduled sequential emulations of subordinate circuits and the routed data transactions among the processors necessitate a large number of execution steps, and this scheme needs to be improved to meet the aim of logic emulation which closely approximates the performance of actual circuits.

In regard to the logic emulation scheme using logic emulation processors, the foregoing prior arts have been problematic in that the matter of a large number of execution steps in need for the scheduled sequential emulations of subordinate circuits and for the routed data transactions among the processors is not treated and, in consequence, the performance close to actual circuits cannot be achieved.

First, execution steps developed by scheduling vary depending on the mapping method of digital circuit model. Specifically, a fact that emulation of a circuit model based on the mapping with gates having more inputs is carried out in a smaller number of steps is revealed by the comparison among, for example, the invention entitled “Hardware Logic Simulator” of U.S. Pat. No. 4,697,241 which maps a circuit to a 2-input/1-output gate, the invention entitled “Multiprocessor for Hardware Emulation” of U.S. Pat. No. 5,551,013 which maps a circuit to a 3-input/1-output gate, and the invention entitled “Check Pointing in an Emulation System” of U.S. Pat. No. 5,822,564 which maps a circuit to a 16-input/4-output gate. Although any of these examples can reduce the number of execution steps based on the mapping with gates having a larger number of inputs, there is a physical limit encountered by the prior arts in their intact forms.

Secondly, execution steps created in the routing process are largely attributable to a limited number of pins of LSI. A logic emulation system uses LSIs having several tens to several hundreds logic emulation processor functions, and therefore it has a narrow bandwidth of data transfer among the LSIs.

### SUMMARY OF THE INVENTION

An object of the present invention is to provide a logic emulation system which accomplishes the further speed-up of operation based on the reduction in the number of stages of digital circuit models and the expansion of the bandwidth of data transfer among LSIs.

In order to achieve the above objective, a module unit of logic emulation processor which runs on a software basis includes one or more than one combination circuit processor which emulates AND-OR converted combination circuit models or memory models consecutively, a plurality of control processors which generate input signals to the combination circuit processor and emulate at least sequential circuit models consecutively, and a plurality of multiplexers each having input signals derived from the output of the combination circuit processor, selecting an input signal in demand of a control processor, and delivering the selected input signal to the control processor.

### BRIEF DESCRIPTION OF THE DRAWINGS

FIG. 1 is a block diagram of a module unit based on an embodiment of this invention;

FIG. 2 is a block diagram of a combination circuit processor based on an embodiment of this invention;

FIG. 3 is a block diagram showing an embodiment of interconnected combination circuit processors;

FIG. 4 is a block diagram showing the emulation of a memory model by the combination circuit processor;

FIG. 5 is a block diagram of a router, multiplexer and control processor based on an embodiment of this invention;

FIG. 6 is a schematic circuit diagram of a combination circuit evaluation unit based on an embodiment of this invention;

FIG. 7 is a schematic circuit diagram of a combination circuit evaluation unit of the case of the interconnection of multiple combination circuit processors;

FIG. 8 is a block diagram showing 16 combination circuit processors which carry out 16-input/16-output logic operations independently without being interconnected;

FIG. 9 is a block diagram showing the arrangement of 32-input/32-output combination circuit processors each formed of four interconnected combination circuit processors;

FIG. 10 is a block diagram showing the arrangement of a 64-input/64-output combination circuit processor which is formed of 16 interconnected combination circuit processors;

FIG. 11 is a block diagram showing the wiring of interconnection of 16 combination circuit processors in three modes;

FIG. 12 is a diagram showing the interconnection of five module units by a complete network;

FIG. 13 is a diagram showing the interconnection of 64 module units by a six-dimensional hypercube;

FIG. 14 is a block diagram of a logic emulation system based on an embodiment of this invention;

FIG. 15 is a block diagram of the control evaluation unit based on an embodiment of this invention;

FIG. 16 is a schematic circuit diagram showing an example of the arrangement of the combination circuit model, sequential circuit model and memory model; and

FIG. 17 is a schematic circuit diagram showing an example of the AND-OR conversion of a combination circuit.

### DESCRIPTION OF THE PREFERRED EMBODIMENTS

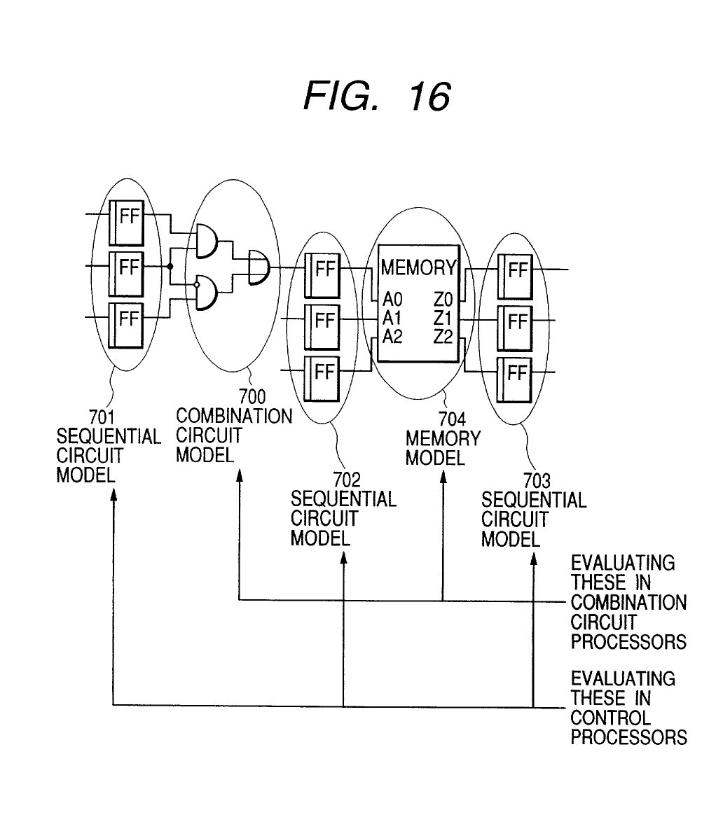

Circuit models which undergo the logic emulation fall into three types, which are combination circuit models, sequential circuit models and memory models. FIG. 16 shows examples of circuit models. A circuit model 700 made up of AND gates and an OR gate is located between sequential circuit models 701 and 702 each made up of flip-flops (FF) . A memory model 704 is located between the sequential circuit model 702 and another sequential circuit model 703. The present invention is intended to perform the high-speed emulation for these three kinds of circuit models.

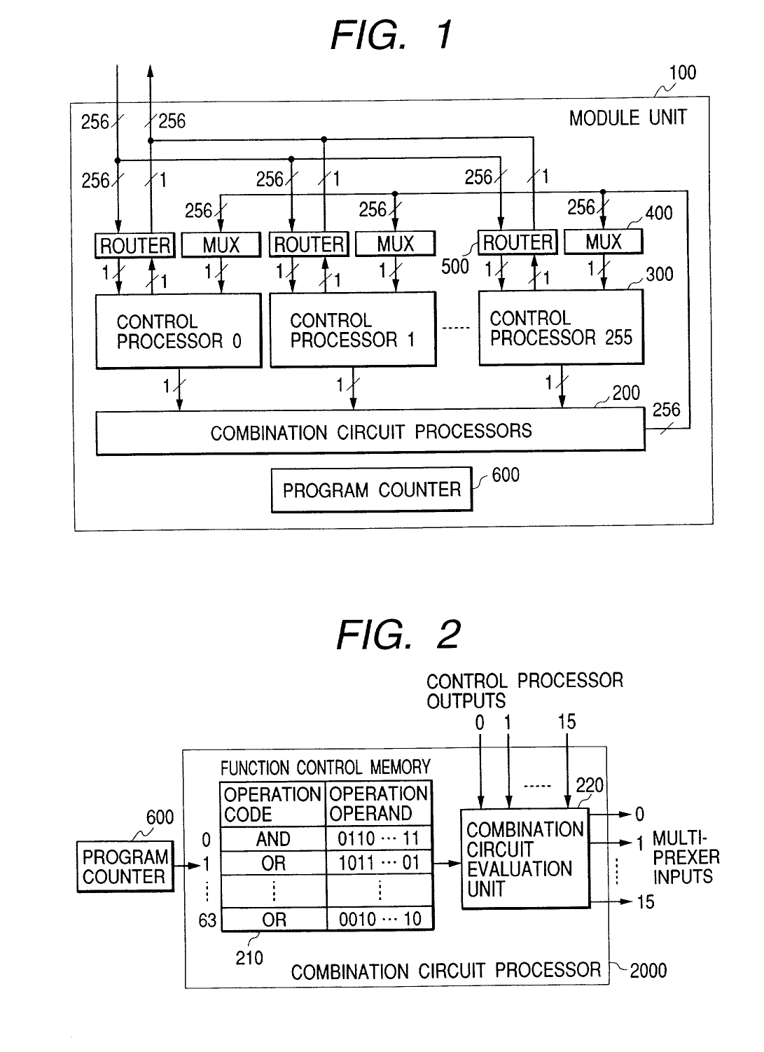

FIG. 1 shows by block diagram a module unit, which is an LSI as an embodiment of this invention. A combination circuit processor 200 emulates combination circuit models and memory models, while control processors 300 emulate mainly sequential circuit models and it also emulates other combination circuit models which are not assigned to the combination circuit processor. The combination circuit processor, which gets input signals from multiple control processors, gives output signals to arbitrary control processors by use of multiplexers (MUX) 400.

The arrangement of processor shown in FIG. 1 is correspondent to the arrangement of the circuit models. Among the circuit models of FIG. 16, the combination circuit model 700 gets input signals from the sequential circuit model 701 and gives an output signal to the sequential circuit model 702. The memory model 704 in synchronous operation gets input signals from the sequential circuit model 702 and gives output signals to the other sequential circuit model 703. The combination circuit model 700 and memory model 704 are emulated by the combination circuit processor 200, while the sequential circuit models 701, 702 and 703 are emulated by the control processors 300.

The combination circuit processor 200 and the control processors 300 are run alternately. Running the combination circuit processor determines the signal values of the combination circuit model and memory model, and running the control processors subsequently determines the signal values of a sequential circuit model. The emulation goes on based on the cyclic implementation of these operations.

The module unit 100 of FIG. 1 includes a number of (e.g.,256) control processors, one or more than one (e.g.,16) combination circuit processor, a number of (e.g.,256) routers 500 which are used to connect multiple module units through buses, and a program counter 600 which times the operation of the control processors 300 and combination circuit processor 200.

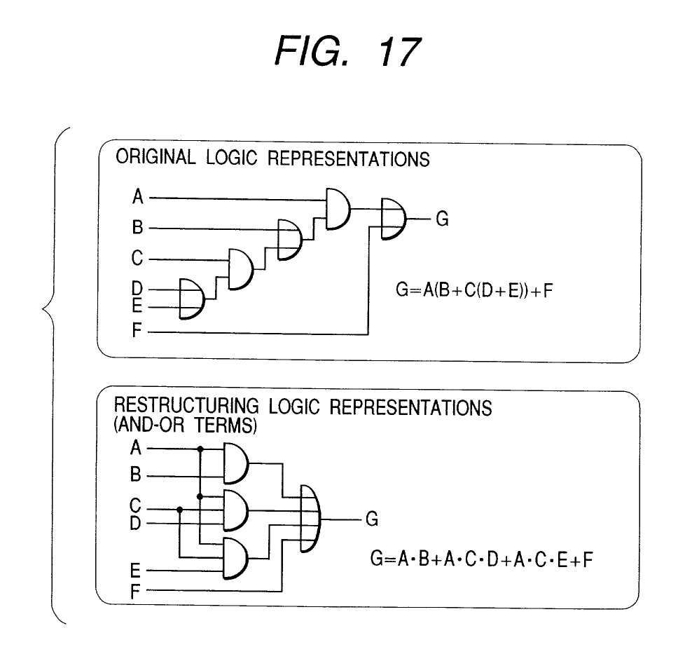

FIG. 17 shows an example of the conversion of a logic function based on the AND-OR conversion which is implemented at the compilation of a combination circuit model. Original function C=A (B+C (D+E) )+F of a 5-stage gate circuit is converted based on the inventive AND-OR conversion into function G=A·B+A·C·D+A·C·E+F of a 2-stage gate circuit. The AND-OR conversion is capable of converting any combination circuit into a 2-stage logic of AND and OR operations.

The combination circuit processor 200 implements AND-OR converted logic operations for multiple inputs and outputs. In the example of FIG. 17, it implements simultaneously AND operations G1=A·B, G2=A·C·D and G3=A·C·E, and subsequently it implements OR operation G=G1+G2+G3+F. Based on the alternate implementation of AND and OR operations, the logic function of the combination circuit model can be evaluated. The AND-OR conversion reduces the number of stages of gates and thus reduces the number of operations of the combination circuit processor 200, whereby the emulation performance is improved.

FIG. 2 shows the arrangement of a unit combination circuit processor 2000 which constitutes the combination circuit processor 200. Unit combination circuit processors of 16 in number, for example, are included in the combination circuit processor 200, and each unit processor 2000 has a combination circuit evaluation unit 220 and a function control memory 210.

The combination circuit evaluation unit 220 implements one of AND operation and OR operation for multiple inputs and outputs (e.g., 16-input/16-output), as will be explained in detail later. The function control memory 210 stores operation codes indicative of the type of logic operation (AND operation or OR operation) and operation operands indicative of the content of operation (validation of inputs and inversion of inputs). The function control memory 210 which stores operation codes and operation operands is controlled by the program counter 600 so that operations take place sequentially. Execution of a pair of AND and OR operations signifies the implementation of emulation of one combination circuit.

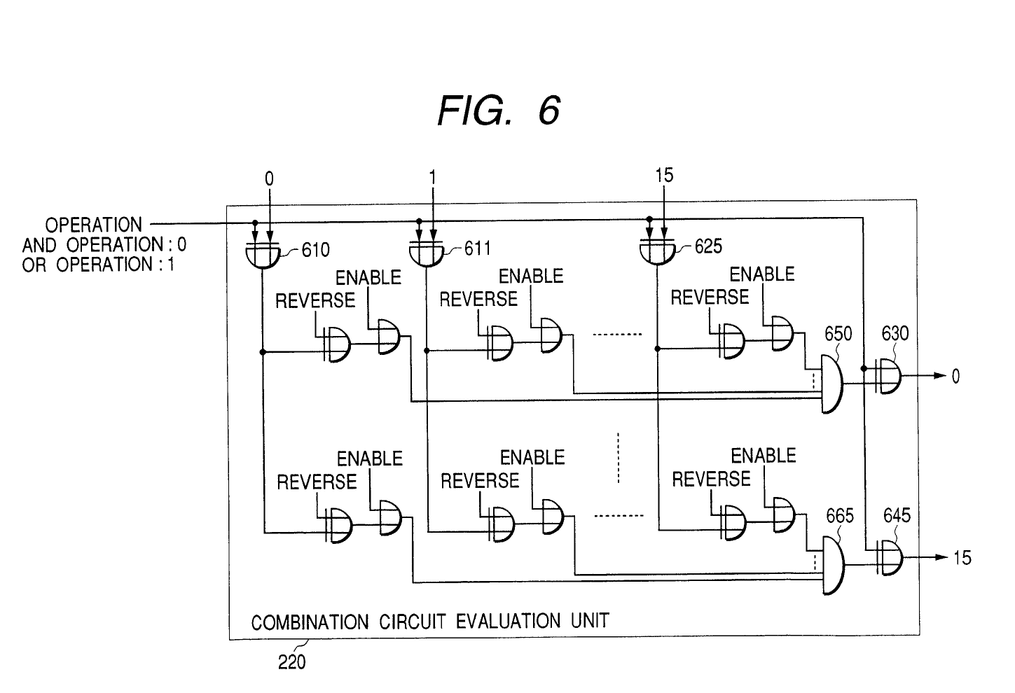

The operation operand has 512 bits, and each pair of 2 bits has a significant value. Specifically, the former bit of a bit pair is the value of invert bit and the latter bit is the value of enable bit in the logic circuit of FIG. 6 which will be explained in later. The above-mentioned bit assignments may be interchanged. Accordingly, the operation operand represents by its value the logic of the combination circuit to be emulated.

The combination circuit evaluation unit can implement simultaneously 16 AND or OR operations for 16 input signals, for example, as shown in FIG. 6. Each input signal corresponds to a variable of logic function. The enable signal provided by the function control memory directs as to whether or not the input signal is to be validated, the invert signal directs as to whether or not the input signal is to be inverted, and the operation code signal executes the AND operation or OR operation selectively.

The function control memory is a memory array which stores 1-bit operation codes for the operation signals and 512-bit (16 inputs by 16 functions by 2 signals) operation operands for the invert signals and enable signals, as shown in FIG. 2. By having 64 memory arrays, for example, the processor can execute a maximum of 64 operation steps. Specifically, it can perform the emulation for 32 pairs of AND and OR operations (32 combination circuits) as sequential operation steps in response to the advancement of the program counter.

Initially, for the execution of a step of AND operation, the operation code gives “0” to EOR (exclusive-OR) gates 610 through 625 and 630 through 645. The operation operand provides the values shown in FIG. 2 for the enable inputs, i.e., “1” for unused variables and “0” for variables in use and for the invert inputs, i.e., “1” or “0” depending on the logic operation. Each of AND gates 650 through 665 performs the AND operation, producing “0” by having at least one “0” input. The output values are given temporarily to the combination circuit evaluation unit 220 through the multiplexers (MUX) 400 of FIG. 1 via the control processor.

Subsequently, the operation code executes a step of OR operation by giving “1” to the EOR gates 610-625 and 630-645, with the rest being identical to the preceding step. The control processor provides the results of AND operation. Each of the AND gates 650-665 performs the OR operation, producing “0” by having at least one “0” input, and these “0” outputs are inverted to “1” by the EORs 630-645. Since each AND gate has inverted inputs, it performs the OR operation.

The reason for the return of the AND operation results temporarily to the control processor and the transfer of the results from the control processor to the combination circuit evaluation unit is to reduce the hardware stuff of the combination circuit evaluation unit 220 based on the sharing by the AND operation and OR operation. Although in this embodiment, the control processor seems to contribute to the emulation of combination circuit, an alternative design is to reinforce the hardware of the combination circuit evaluation unit 220 so that it performs the AND operation and OR operation by itself in a serial manner.

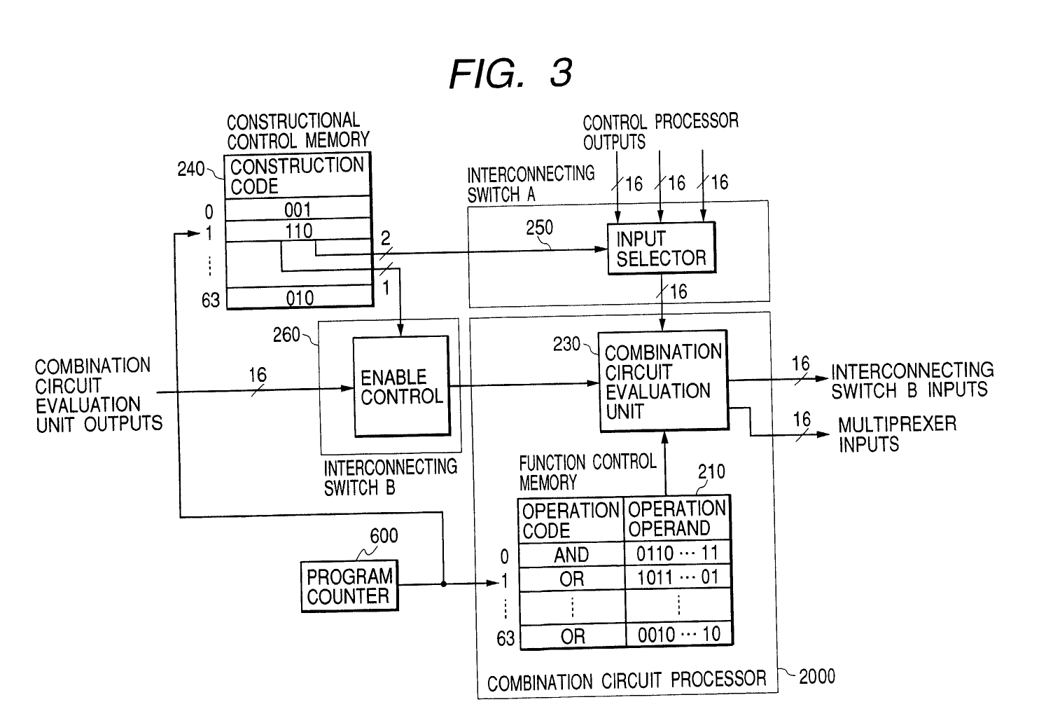

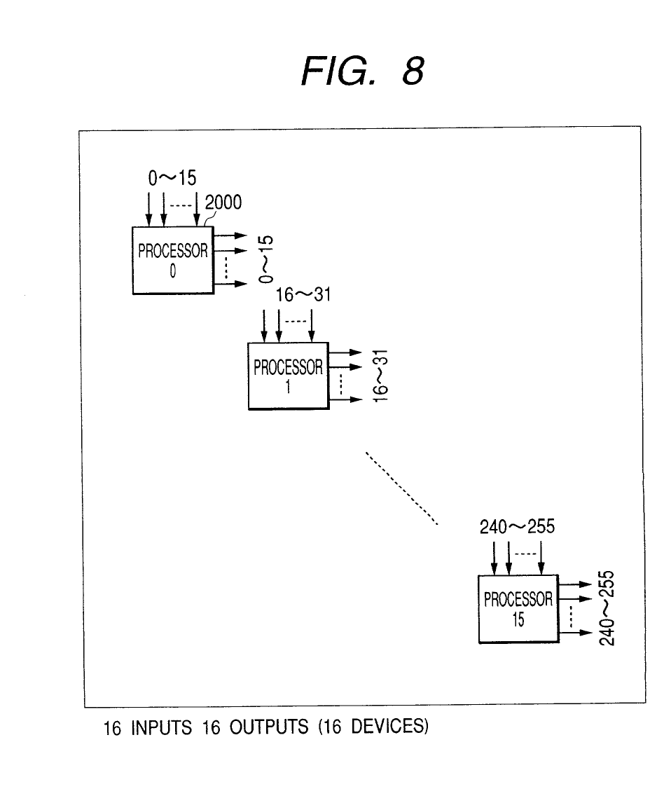

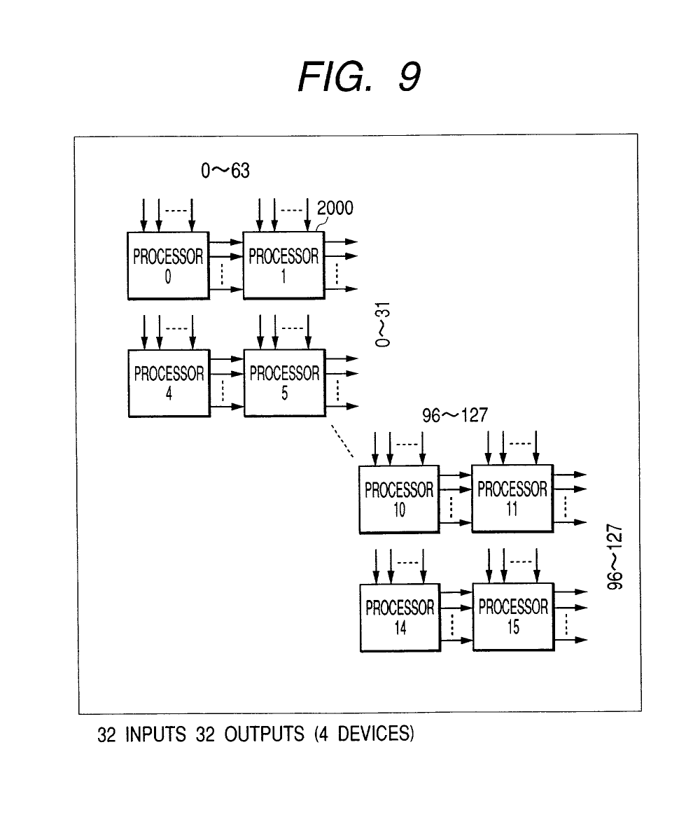

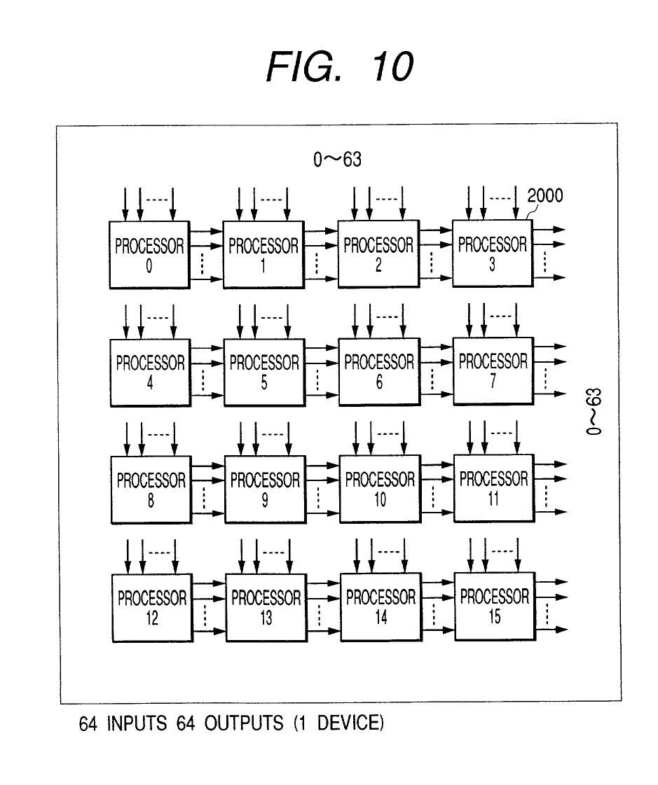

FIG. 3 shows an embodiment of the interconnection of a plurality of the unit combination circuit processor 2000 explained above. FIG. 8 through FIG. 10 show three different connection modes of unit processors 2000. Shown in FIG. 8 is the case where 16 unit combination circuit processors, which are not interconnected, implement 16-input/16-output logic operations independently. Shown in FIG. 9 is the case where four unit combination circuit processors, which are interconnected, implement 32-input/32-output logic operations. Shown in FIG. 10 is the case where 16 unit combination circuit processors are interconnected to form a 64-input/64-output combination circuit processor. The term “interconnection” mentioned here is the lateral connection on the drawing, and each unit combination circuit processor receives output signals of a control processor 300 coming in downwardly at the top.

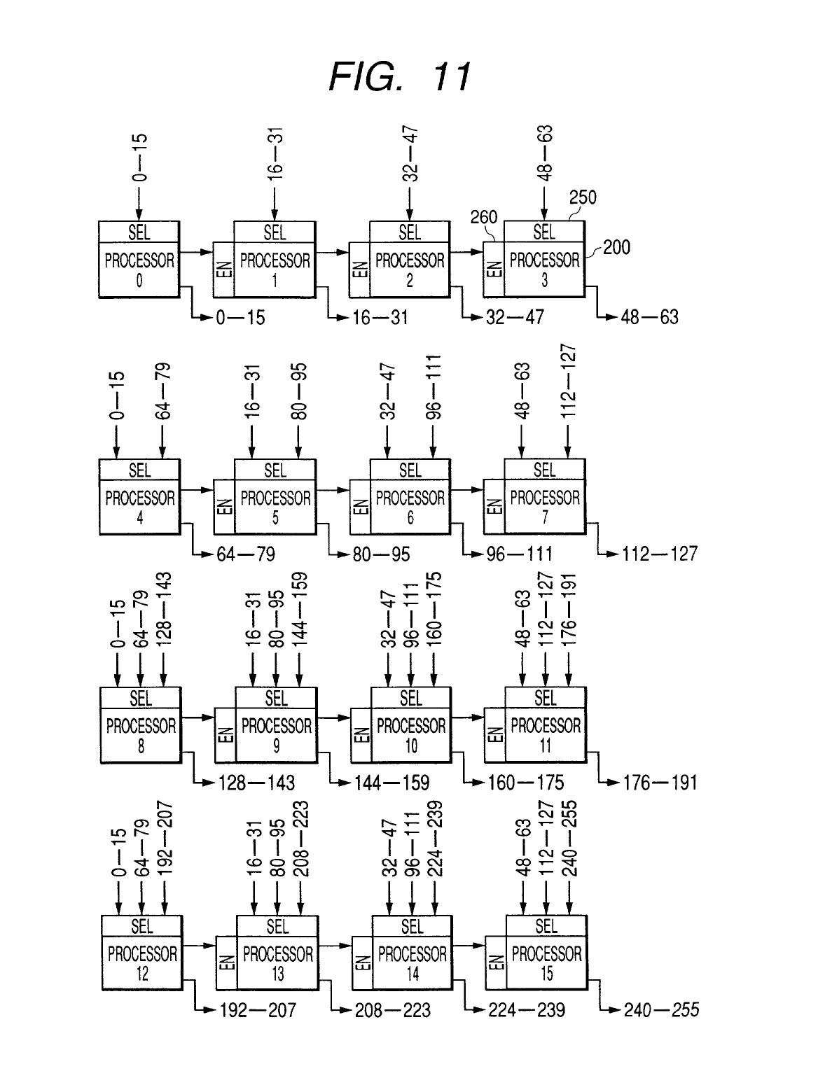

The configuration of FIG. 8 is suitable for combination circuits of a relatively small scale, the configuration of FIG. 10 is suitable for large-scale combination circuits, and the configuration of FIG. 9 is intermediate. Unit combination circuit processors are simply termed “processors” in FIG. 8, FIG. 9, FIG. 10 and FIG. 11.

In FIG. 3, a constructional control memory 240 has its 2 bits fed to an input selector, which then selects an incoming output of a control processor in the case of one of connection modes shown in FIG. 8 through FIG. 10, as will be explained in more detail later. A remaining bit is used to direct as to whether or not the output of the combination circuit evaluation unit 230 is to be received.

The combination circuit processors of FIG. 3 are interconnected by interconnecting switches A250 and B260 in three modes shown in FIG. 8 through FIG. 10 in accordance with the construction codes in the constructional control memory 240. The interconnecting switch A selects a control processor output signal and gives it to the combination circuit processor. The interconnecting switch B controls as to whether or not the output signal of the neighboring combination circuit processor is to be connected.

FIG. 11 shows a specific wiring for interconnecting 16 combination circuit processors in three modes. The figure shows the input sourcing control processor numbers and output destining control processor numbers for each combination circuit processor. Indicated by EN is the enable control by the interconnecting switch B which directs as to whether other combination circuit evaluation unit output is to be connected in FIG. 3, SEL indicates the input selector of the interconnecting switch A in FIG. 3. For example, processor #7 selects inputs from control processors #112-#127 in the case of connection mode of FIG. 8, or selects inputs from control processors #48-#63 in the case of connection mode of FIG. 9 or FIG. 10. In another example, processor #15 selects inputs from control processors #240-#255 in the case of connection mode of FIG. 8, or selects inputs from control processors #112-#127 in the case of connection mode of FIG. 9. Input/output selection is based on the construction codes in the constructional control memory 240. The multiplexer inputs of FIG. 3 are shown as processor outputs in FIG. 11, and these signals are fed to the multiplexers 400 of FIG. 1.

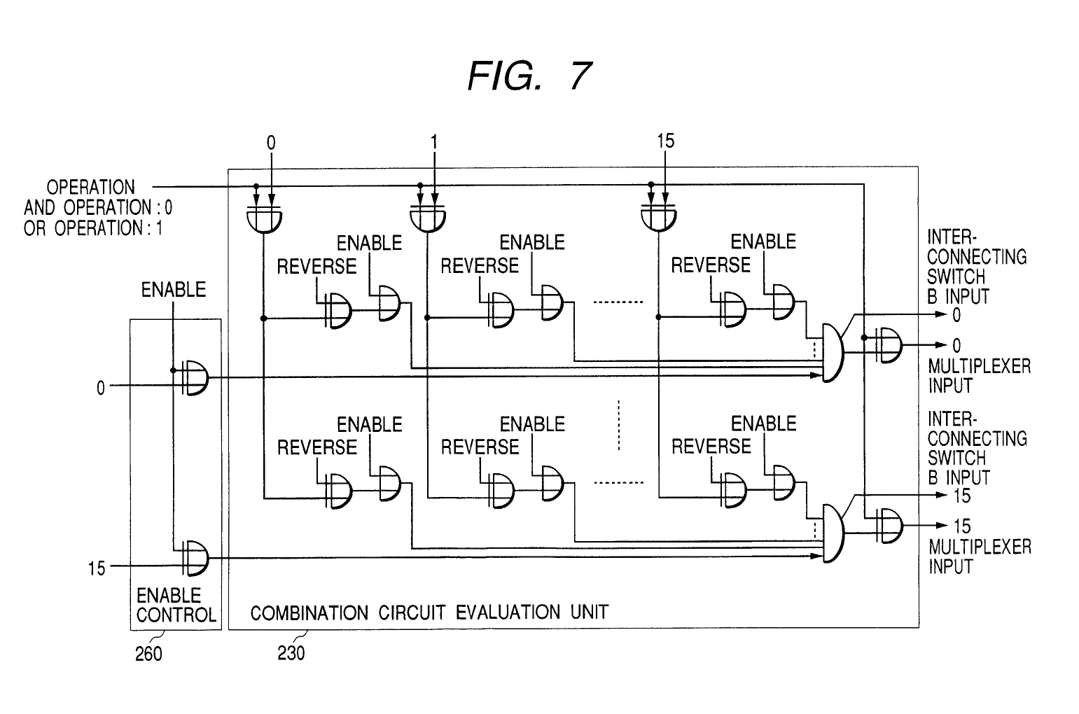

FIG. 6 explains the fundamental arrangement and operation of the combination circuit evaluation unit 220, and the actual circuit arrangement of the case of combining a number of unit combination circuit processors 2000 is as shown in FIG. 7. The combination circuit evaluation unit of FIG. 3 gets the output signal of the left-neighboring combination circuit processor which is gated by enable control by the interconnecting switch B, and gives the evaluation result to the right-neighboring combination circuit processor, as shown in FIG. 7.

By interconnecting a number of combination circuit processors in several configurations, it is possible to deal with many kinds of logic functions of different numbers of inputs and outputs.

The constructional control memory is a memory array which stores 3-bit construction codes (2-bit input selector signals and 1-bit enable control signals). By having 64 memory arrays, for example, the processors can execute a maximum of 64 operation steps. The processors can perform logic functions while being altered in interconnection at each operation step in response to the advancement of the program counter.

By switching the interconnection mode of the unit combination circuit processors 2000 dynamically in accordance with the number of inputs and number of outputs of the logic function to be evaluated, the resource of combination circuit processors can be used effectively.

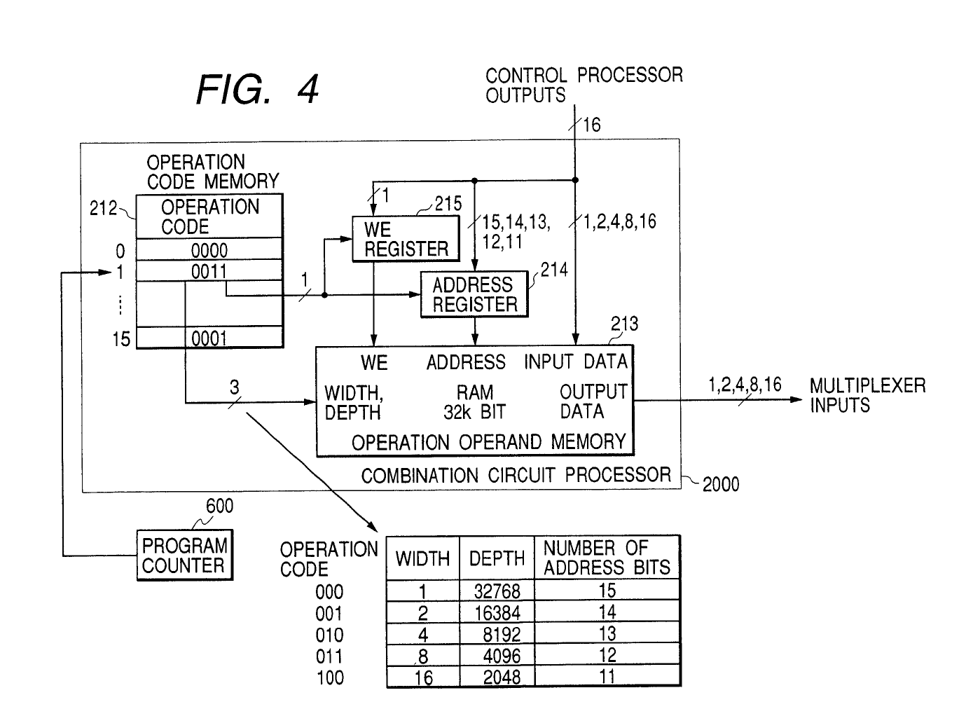

FIG. 4 shows an embodiment of the emulation of memory model by the unit combination circuit processor 2000. The unit combination circuit processors can emulate combination circuit models as well as memory models. The function control memory 210 shown in FIG. 2 is a random access memory having a storage capacity of more than 32K bits, and therefore can emulate a 32K-bit memory by writing and reading out data. A random access memory (RAM) 213 in FIG. 4 is an asynchronous SRAM, which gets input data and write enable signal (WE) from a control processor and gives output data to a multiplexer (or other interconnected unit combination circuit processor).

The unit combination circuit processor can emulate a RAM model based on the read/write control for the RAM 213 by use of the WE signal, or can emulate a ROM model based on data reading from the RAM 213 without using the WE signal. Emulation of the synchronous operation of a RAM model or ROM model is carried out by emulating the input register and output register with control processors, with the operation being synchronized with the clock of the memory model.

An address register 214 and WE (write enable signal) register 215 in FIG. 4 operate to latch the output signals of a control processor in accordance with the contents of a operation code memory 212. The control processor releases an address and input data alternately, and these registers latch the output signals by being timed to the address output.

The RAM 213 in FIG. 4 has the same numbers of input and output and the same memory capacity as those of the function control memory 210 of FIG. 2. The function control memory may be designed, with the intention of its efficient use, to have two functions of storing the control information of the combination circuit evaluation unit in case the combination circuit processor emulates a combination circuit model, or storing the content of memory model in case the processor emulates a memory model.

The RAM 213 in FIG. 4 can have its memory width and depth switched dynamically in accordance with the contents of the operation code memory 212. For example, a RAM of 32K bits designed to select a data width (number of bits) among 1, 2, 4, 8 and 16 will have 15, 14, 13, 12 and 11 address bits, respectively. This function enables the high-speed emulation of memory models having a variety of data widths.

The operation code memory 212 in FIG. 4 is a memory array which stores operation codes each including a WE bit, a timing signal bit, and 3 bits indicative of the memory width and depth. By having 64 memory arrays, for example, the processor can execute a maximum of 64 operation steps sequentially in response to the advancement of the program counter. It is possible for a single RAM 213 to emulate a number of memory models having different data widths.

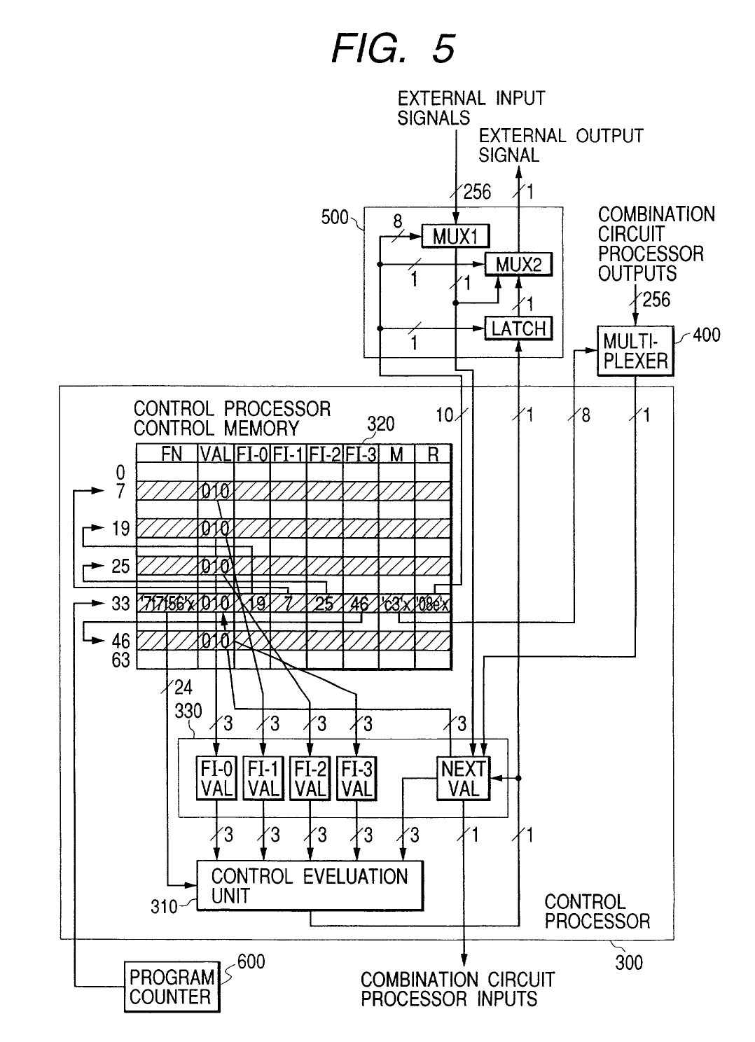

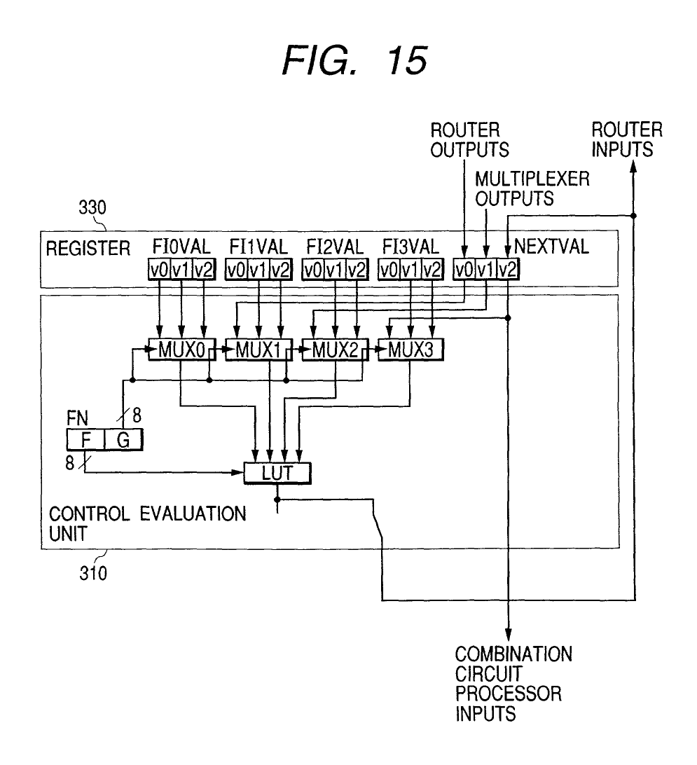

FIG. 5 shows an embodiment of the router 500, multiplexer 400 and control processor 300. Their arrangement and operation will be explained in connection with FIG. 15 which shows the details of the control evaluation unit 310 included in the control processor 300 of FIG. 5.

The router 500 of FIG. 5 is made up of a latch which holds the operation result of the control processor, a multiplexer MUX1 which selects one of 256 external input signals, and another multiplexer MUX2 which selects the MUX1 output or the latch output. The MUX1 output becomes the input signal of the control processor and the latch output becomes the output signal to the outside. Using this router can construct buses for interconnecting a number of module units 100.

The multiplexer 400 of FIG. 5 selects one of 256 output signals of the combination circuit processors.

The control processor 300, which includes the control evaluation unit 310 and a register 330 as shown in FIG. 5, implements a multi-input (e.g.,4-input)/1-output logic function which represents a sequential circuit model and a combination circuit model at each step of the program counter 600. The register 330 has fields FI-0VAL, FI-1VAL, FI-2VAL and FI-3VAL for holding four input signals and field NEXTVAL for holding the logic operation result (used for the next sequential circuit emulation). Prior to the operation of the control evaluation unit 310, values of fields FI-0, FI-1, FI-2 and FI-3 of the control processor control memory are loaded to the register fields FI-OVAL, FI-1VAL, FI-2VAL and FI-3VAL. The control evaluation unit implements the logic operation specified by FN (type of logic operation) indicated by the program counter for the input values of logic function provided by the fields FI-OVAL, FI-1VAL, FI-2VAL, FI-3VAL and NEXTVAL (result of previous logic operation), and saves the logic operation result in the NEXTVAL.

The control processor 300 of FIG. 5 also controls the router 500 and multiplexer 400. By entering the selection signal for the MUX1 and MUX2 provided by field R of the control processor control memory, the router can have its routing path switched at each step. Similarly, by entering the selection signal for the multiplexer 400 provided by field M of the control processor control memory, the input from the combination circuit processor can be switched at each step. The control processor control memory also stores in R the timing signal for data latching by the router 500.

The register field NEXTVAL of FIG. 5 has 3 bits for holding the outputs of the control evaluation unit, MUX1 and multiplexer 400, and after these three signals have been held, they are stored in the field of VAL indicated by the program counter.

FIG. 15 shows an embodiment of the control evaluation unit. Multiplexers MUX0 through MUX3 select four signals out of the contents of the register fields FI-0VAL, FI-1VAL, FI-2VAL, FI-3VAL and NEXTVAL. The control evaluation unit implements an logic operation for these four input signals based on a lookup table LUT. The LUT can deal with 65536 (16th power of 2) kinds of logic operations in accordance with the value of F (16 bits) read out of the FN field of the control processor control memory.

The operation of the control processor 300 arranged as shown in FIG. 5 and FIG. 15 and described above briefly will be explained in detail.

The control processor control memory 320 is a memory array having fields FN through R, and one row of the memory represents one sequential circuit. Rows #0 through #63 are executed sequentially under control of the program counter 600. The FN is hexadecimal data of logic function to be stored in the lookup table. Signal value VAL has the immediate content of NEXTVAL. FI-0 through FI-3 are array (row) numbers which depend on the arrangement of the sequential circuit to be emulated. M is a hexadecimal signal for controlling the multiplexer 400, and it determines the output of the unit combination circuit processors 2000 to be taken into the self control processor. R is to select one bit out of the external input signal, and also selects as to whether the signal is to be sent to other control processor via the MUX2. It produces a trigger signal for the latch to hold the emulation result provided by the control evaluation unit 310.

The register 330 has four latches, of which FI-0VAL holds the signal value of the row pointed by the FI-0, and FI-1VAL through FI-3VAL hold signal values of the rows pointed by the FI-1 through FI-3, respectively. NEXTVAL holds the output of the control evaluation unit 310, a 1-bit signal selected out of the combination circuit output and a signal selected out of the external input signal. These signals are stored in the VAL field of the control processor control memory 320.

In FIG. 15, the former 8 bits are stored in the lookup table LUT, and the latter 8 bits are given to the multiplexers MUX0-MUX3 which select one bit each from the latch outputs of the register 330. Selection by the multiplexers is dependent on the scale of the circuit model. The lookup table LUT is referenced based on the selected addressing bit to read out the emulation result.

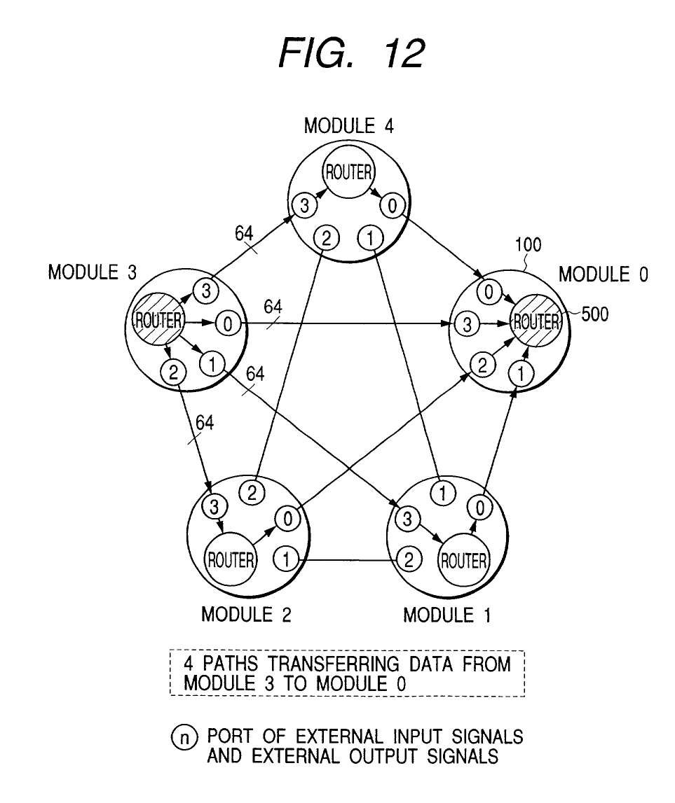

FIG. 12 shows an embodiment of the interconnection of five module units by a complete network. An example of operation in which 256 signals from module #3 are transferred to module #0 via a number of paths will be explained. The module #3 initially groups the 256 signals into four sets of 64 signals, and transfers the four signal sets to the four neighboring modules #0, #1, #2 and #4.

Subsequently, the modules #0, #1, #2 and #4 transfer their signal sets to the module #0. Using the paths via the modules #1, #2 and #4 in this manner besides the direct path from module #3 to module #0 results in an expanded bandwidth of data transfer among the modules. For the simultaneous data transfer, the operation is scheduled at compilation so that path contention does not occur. Signals are sent to the intermediate modules through a shortcut path from the MUX1 to MUX2 in the router 500 shown in FIG. 5.

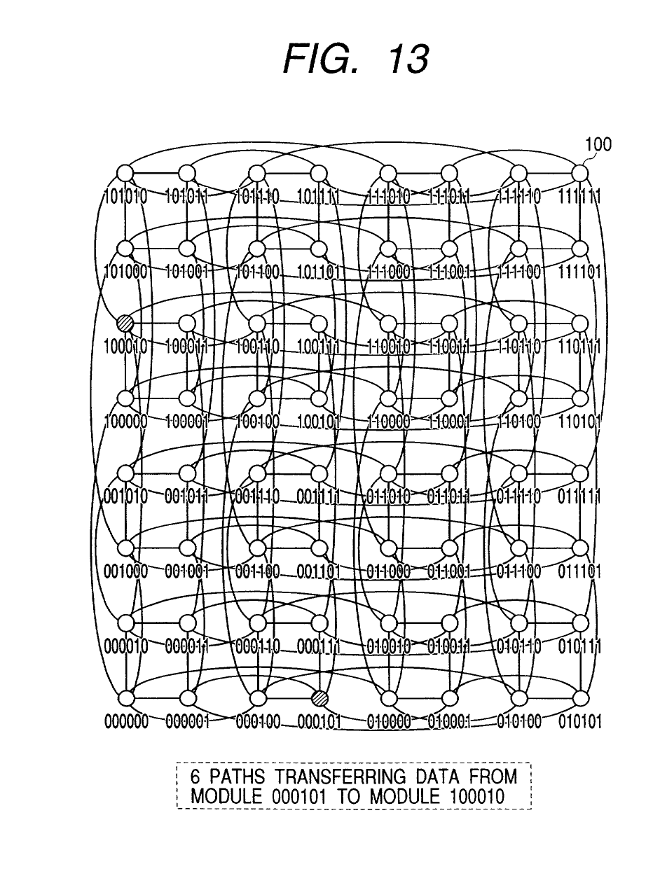

FIG. 13 shows an embodiment of the interconnection of 64 module units through buses of a six-dimensional hypercube. Generally, a hypercube network determines a route so that the length is minimum based on the e-cube routing algorithm (e.g., it is described in publication “Computer Aided Design”, p.325, written by B. Wilkinson, published by Toppan Corp., April 1994). A message sending module has a node address of P=Pₙ₋₁Pₙ₋₂ . . . P₁P₀, and a message receiving module has a node address of D=Dnₙ₋₁Dₙ₋₂ . . . D₁D₀. The node address is a unique binary number given to each module unit. Each bit of P and D undergoes the exclusive-OR operation to get R=Rₙ₋₁Rₙ₋₂ . . . R₁R₀. For the i-th bit at which Ri=1, the same bit position of P is inverted, and a path is determined. For example, in determining a path from node P=000101 to node D=100010 of a six-dimensional hypercube, R becomes 100111, and the node P has its bit positions i=5,2,1 and 0 inverted to obtain a path. Specifically, the P=000101 has its 5th bit inverted to become 100101, next has its-2nd bit inverted to become 100001, has its 1st bit inverted to become 100011, and finally has its 0th bit inverted to get a path to the destination node D=100010.

Next, another example of routing from node P=000101 to node D=100010 via a number of paths with the intention of multiplexed data transfer will be explained in FIG. 13. This is based on an extended e-cube routing algorithm. Initially, six immediate paths are determined. Inverting the P at one bit position at a time provides five immediate paths of Q5=100101, Q4=010101, Q3=001101, Q2=000001, Q1=000111 and QO=000100. Subsequently, the e-cube routing algorithm is applied to Q5 through Q0. In this case, for the path of node Q1, bits are scanned through downward by starting at the (i-i)th bit position (from the 5th bit in the case of i=0) so that paths do not overlap. The exclusive-OR of the Q5 and D makes 000111, and inverting bits of i=2,1 and 0 sequentially for the node Q5 provides a path. The exclusive-OR of the Q4 and D makes 110111, and inverting bits of i=2,1,0,5 and 4 sequentially for the node Q4 provides a path. The exclusive-OR of the Q3 and D makes 101111, and inverting bits of i=2,1,0,5 and 3 sequentially for the node Q3 provides a path. The exclusive-OR of the Q2 and D makes 100011, and inverting bits of i=1, 0 and 5 sequentially for the node Q2 provides a path. The exclusive-OR of the Q1 and D makes 100101, and inverting bits of i=0,5 and 2 sequentially for the node Q1 provides a path. The exclusive-OR of the Q0 and D makes 100110, and inverting bits of i=5,2 and 1 sequentially for the node Q0 provides a path. Using a number of routes results in an expanded bandwidth of data transfer among the modules. For the simultaneous data transfer, routes are selected and scheduled at compilation so that path contention does not occur.

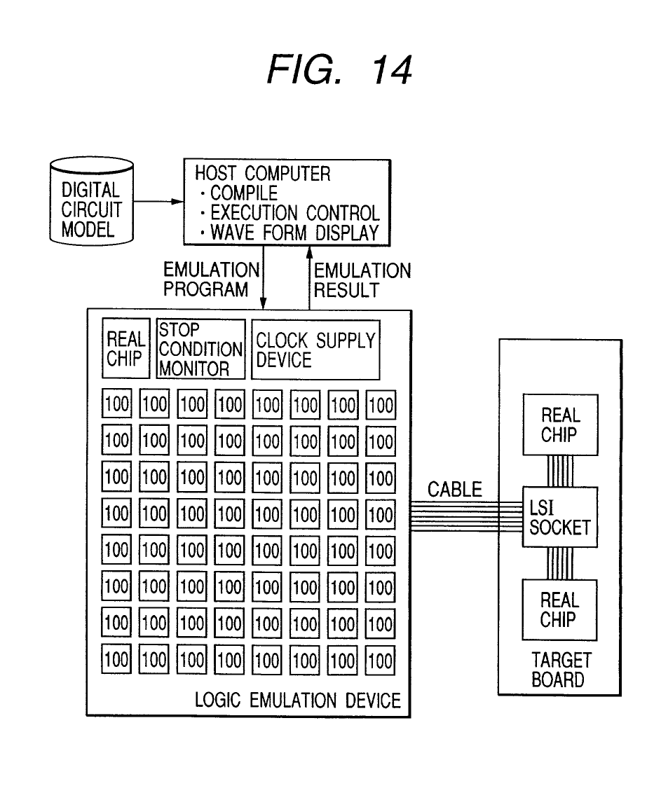

FIG. 14 shows an embodiment of the logic emulation system. In the system, a host computer reads in source data of a digital circuit model and compiles an emulation program. The host computer loads the emulation program into a logic emulation processor. The logic emulation processor includes a number of module units 100 which operate in synchronism with a clock signal provided by a clock generator. As top condition monitor detects the arrival of the stop condition to quit the supply of clock and sends the result of emulation to the host computer. It is also possible to transact signal values of the circuit model with the logic emulation processor or display waveforms of the circuit model based on the operation control of the host computer. The logic emulation processor can perform the logic emulation of a circuit model, with a CPU and memory LSI chips being connected to it. By connecting the logic emulation processor to an LSI socket of a target board with a cable, the in-circuit emulation can be performed.

According to the inventive scheme of logic emulation based on the logic emulation processor, it becomes possible to reduce the number of stages of digital circuit model and expand the bandwidth of data transfer among LSIs, whereby the speed-up of logic emulation can be accomplished.

1. A module unit of a logic emulation processor comprising:
one or more than one unit combination circuit processor having a plurality of input signals and a plurality of output signals and operating to emulate an AND-OR converted combination circuit model or memory model;
a plurality of control processors each having a plurality of input signals and one or more than one output signal and operating to generate said input signals of said unit combination circuit processor and emulate a sequential circuit model; and
a plurality of multiplexers each receiving said output signals of said unit combination circuit processors, selecting a signal in demand of a control processor, and delivering the selected signal to said control processor.

2. A module unit of a logic emulation processor according to claim 1, wherein said unit combination circuit processor includes a function control memory which stores operation codes indicative of AND or OR operations and operation operands, and a combination circuit evaluation unit which simulates the AND operation of said AND-OR converted combination circuit for said output signal of said control processor based on the entry of a value of operation code indicative of logical AND and a value of operand and simulates the OR operation of said AND-OR converted combination circuit for said output signal of said control processor based on the entry of a value of operation code indicative of logical OR and a value of operand.

3. A module unit of a logic emulation processor according to claim 2, wherein said operand includes information for directing as to whether or not the input signal of said combination circuit evaluation unit is to be validated and whether or not said signal is to be inverted.

4. A module unit of a logic emulation processor according to claim 1, wherein said unit combination circuit processor includes an interconnecting switch for interconnecting said unit combination circuit processors.

5. A module unit of a logic emulation processor according to claim 4, wherein said combination circuit processor includes an input selector which selects one of multiple sets of outputs of said control processors, and a constructional control memory which stores construction codes indicative of different interconnections of said unit combination circuit processors based on which said input selector selects one of said multiple sets of outputs.

6. A module unit of a logic emulation processor according to claim 1, wherein said unit combination circuit processor includes a memory which receives the output signals of said control processor as input data, write or read address and write enable signal and releases output data as output of said unit combination circuit processor.

7. A module unit of a logic emulation processor according to claim 2, wherein said function control memory is designed to emulate a memory device and said function control memory receives the output signals from said control processor as input data, write or read address and write enable signal and releases output data as output of said unit combination circuit processor.

8. A module unit of a logic emulation processor according to claim 6 including an operation code memory which stores operation codes indicative of the width and depth of said memory, said data being written or read out in accordance with a data width specified by a code which is read out of said operation code memory.

9. A logic emulation processor comprising:
module units interconnected in said logic emulation processor, each of which includes one or more than one unit combination circuit processor having a plurality of input signals and a plurality of output signals and emulating a combination circuit model or memory model, a plurality of control processors each having a plurality of input signals and one or more than one output signal and operating to generate said input signals to said unit combination circuit processor and emulate a sequential circuit model, and a plurality of multiplexers each receiving said output signals of said unit combination circuit processor, selecting a signal in demand of a control processor, and delivering the selected signal to said control processor;
means for interconnecting said module units of M in number based on a complete network; and
means for grouping signals to be transferred among said module units into a maximum of M-1 sets of signals and transferring said divided signal sets via a plurality of paths through the neighboring module units.

10. A logic emulation processor comprising:
module units interconnected in said logic emulation processor, each of which includes one or more than one unit combination circuit processor having a plurality of input signals and a plurality of output signals and emulating a combination circuit model or memory model, a plurality of control processors each having a plurality of input signals and one or more than one output signal and operating to generate said input signals to said unit combination circuit processor and emulate a sequential circuit model, and a plurality of multiplexers each receiving said output signals of said unit combination circuit processor, selecting a signal in demand of a control processor, and delivering the selected signal to said control processor;
means for connecting one of said module unit to other neighboring module units of N in number through buses based on an N-dimensional hypercube; and
means for grouping signals to be transferred among said module units into a maximum of N sets of signals, implementing a first procedure of determining immediate transfer paths of N in number from a message sending module having a node address of P=Pₙ₋₁Pₙ₋₂ . . . P₁P₀ to a message receiving module having a node address of D=Dₙ₋₁Dₙ₋₂ . . . D₁D₀ (the node address is a unique binary number given to each module unit) by inverting the node address P at one bit position at a time thereby to obtain Qₙ₋₁=(not Pₙ₋₁) Pₙ₋₂ . . . P₁P₀, Qₙ₋₂=Pₙ₋₁ (not Pₙ₋₂ . . . P₁P₀, . . . , Q₁=Pₙ₋₁Pₙ₋₂ . . . (not P₁)P₀, and Q₀=Pₙ₋₁Pₙ₋₂ . . . P₁ (not P₀), implementing a second procedure of taking exclusive logical sums between Qₙ₋₁ through Q₀ and D for individual bits thereby to obtain Rₙ₋₁ through R₀, implementing a third procedure, which is repeatedly for values of i of n−1 through 0, of inverting Qᵢ at a same bit position as Rᵢ having a value of “1” sequentially by scanning through the bits downward from the (i−1) th bit position of Rᵢ (from the (n−1)th bit position in the case of i=1) thereby to determine a path from Qᵢ to D, and transferring said divided signal sets from P to D by using the determined paths of N in number.
